(19) United States
(12) Patent Application Publication
(10) Pub. No.: US 2026/0025194 A1
(43) Pub. Date: Jan. 22, 2026

(54) SYSTEM AND METHOD FOR MINING MOBILE EMERGENCY COMMUNICATION

(71) Applicant: CCTEG Coal Mining Research Institute, Beijing (CN)

(72) Inventors: Chenxin Li, Beijing (CN); Liya Zhang, Beijing (CN); Shouxin Kang, Beijing (CN); Yue Zhao, Beijing (CN); Kaihua Liu, Beijing (CN); Qingyong Meng, Beijing (CN); Wenzhen Wu, Beijing (CN); Yuan Fu, Beijing (CN); Biao Li, Beijing (CN); Senyi Tao, Beijing (CN); Zefang Li, Beijing (CN); Xiaodi Jia

(21) Appl. No.: 18/998,035

(22) PCT Filed: Feb. 2, 2023
(86) PCT No.: PCT/CN2023/074311

§ 371 Date: Jan. 23, 2025

(30) Foreign Application Priority Data
Aug. 15, 2022 (CN) 202210977260.9

(51) Int. Cl. H04B 7/155; H04W 4/90; H04W 72/0446; H04W 72/0453

(52) U.S. Cl. CPC H04B 7/15542; H04W 4/90; H04W 72/0446; H04W 72/0453

(57) ABSTRACT

A system for mining mobile emergency communication includes: a management platform, a transmission network, a repeater and a terminal. The terminal is configured to collect and generate communication data, and to send the communication data to the repeater; the repeater is connected with the transmission network and/or connected with another repeater in a wireless way for building a transmission link, the transmission link transmitting the communication data sent by the terminal based on a preset rule; the management platform is configured to monitor and schedule the transmission link, and to schedule the communication data; and the transmission network is configured to connect the repeater and the management platform, and to transmit the communication data and link regulation and control data.

### CROSS-REFERENCE TO RELATED APPLICATIONS

This application is a U.S. national phase application of International Application No. PCT/CN2023/074311, filed on Feb. 2, 2023, which claims priority to Chinese Patent Application 2022109772609, filed with the State Intellectual Property Office of P. R. China on Aug. 15, 2022, the entire contents of which are incorporated herein by reference.

### TECHNICAL FIELD

The disclosure relates to a field of mining communication technologies, and particularly to a system and a method for mining mobile emergency communication.

### BACKGROUND

Emergency rescue and emergency handling is an important topic in coal mine safety production. When a safety accident in coal mine occurs, rescuers need to go deep into mine accident for frontline rescue. Building an emergency communication system quickly to realize information transmission is a crucial link of rescue support, which plays an important role in reducing casualties and efficiently handling accidents.

In the related art, a multi-device wireless (Wi-Fi) network communication technology with an unauthorized frequency band is generally employed as a relay and coverage solution.

In this way, since multiple devices relay forward transmission and return transmission in the same frequency band, it is easy to cause co-frequency interference, which affects a quality of communication network. Moreover, establishment of a transmission link requires maintaining a complicated routing process, such that a field debugging efficiency is low, an additional time delay is introduced, the emergency communication efficiency is insufficient, and the effect is poor.

### SUMMARY

A first aspect of embodiments of the disclosure provides a system for mining mobile emergency communication, including: a management platform, a transmission network, a repeater and a terminal. The terminal is configured to collect and generate communication data, and to send the communication data to the repeater. The repeater is connected with the transmission network and/or connected with another repeater in a wireless way for building a transmission link. The transmission link transmits the communication data sent by the terminal based on a preset rule. The management platform is configured to monitor and schedule the transmission link, and to schedule the communication data. The transmission network is configured to connect the repeater and the management platform, and to transmit the communication data and link regulation and control data.

A second aspect of embodiments of the disclosure provides a method for mining mobile emergency communication, performed by a system for mining mobile emergency communication. The method includes: obtaining communication data sent by a terminal; transmitting the communication data based on a preset rule, and sending the communication data to a management platform; and receiving the communication data by the management platform, and performing emergency communication based on the communication data.

### BRIEF DESCRIPTION OF THE DRAWINGS

The above and/or additional aspects and advantages of the disclosure will be apparent and easily understood from the following description of embodiments taken in combination with the accompanying drawings, in which:

FIG. 1 is a schematic diagram illustrating a system for mining mobile emergency communication according to an embodiment of the disclosure;

FIG. 2 is a flow chart illustrating transmission based on a preset rule according to another embodiment of the disclosure;

FIG. 3 is a schematic diagram illustrating allocating frequency domain resources for transmission according to another embodiment of the disclosure;

FIG. 4 is a flow chart illustrating transmission based on a preset rule according to another embodiment of the disclosure;

FIG. 5 is a schematic diagram illustrating allocating transmission resources according to another embodiment of the disclosure;

FIG. 6 is a flow chart illustrating a method for mining mobile emergency communication according to an embodiment of the disclosure; and

FIG. 7 is a schematic diagram illustrating transmission of communication data according to another embodiment of the disclosure.

### DETAILED DESCRIPTION

Description will be made in detail below to embodiments of the disclosure. Examples of embodiments are illustrated in the accompanying drawings, in which, the same or similar numbers represent the same or similar elements or elements with the same or similar functions. Embodiments described below with reference to the accompanying drawings are exemplary, which are intended to explain the present disclosure and do not be understood a limitation of the present disclosure. Instead, embodiments of the disclosure include all changes, modifications and equivalents that fall within the spirit and connotation of the appended claims.

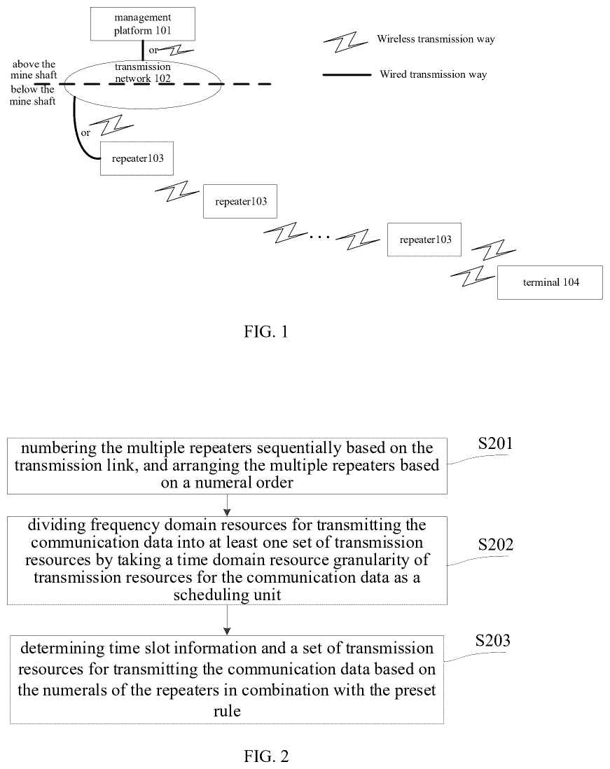

FIG. 1 is a schematic diagram illustrating a system for mining mobile emergency communication according to an embodiment of the disclosure;

As illustrated in FIG. 1, the system for mining mobile emergency communication according to embodiments of the disclosure includes a management platform 101, a transmission network 102, a repeater 103, and a terminal 104, in which:

the terminal 104 is configured to collect and generate communication data, and to send the communication data to the repeater 103;

the repeater 103 is connected with the transmission network 101 and/or connected with another repeater 103 in a wireless way for building a transmission link, the transmission link transmitting the communication data sent by the terminal based on a preset rule;

the management platform 101 is configured to monitor and schedule the transmission link, and to schedule the communication data; and

the transmission network 102 is configured to connect the repeater 103 and the management platform 101, and to transmit the communication data and link regulation and control data.

The terminal 104 in embodiments of the disclosure may be, such as, a mine mobile phone, a smart phone, a smart bracelet, a life sensor, an environment-aware device, etc., which is not limited herein.

The communication data may be, such as, speech information, video information, positioning information, and vital sign parameter information of an underground rescuer. Of course, the communication data may also be data information of a rescue site environment, such as methane concentration information and temperature and humidity information of a rescue site, which is not limited herein. The terminal 104 may collect and generate the communication data and send the communication data to the repeater 103.

The link regulation and control data are data information for regulating and controlling the transmission link formed by multiple repeaters 103, and the link regulation and control data may include transmission resource allocation information of the repeater 103, management information of the transmission link, and so on, which is not limited herein.

In some embodiments of the disclosure, the repeater 103 is connected to the transmission network 102 in the wired or wireless way, and is connected to another repeater 103 in a wireless transmission way of a 5th generation mobile communication technology (5G) direct communication, to form the transmission link.

In embodiments of the disclosure, there are multiple repeaters 103, and the multiple repeaters 103 are connected in turn to form the transmission link, and the first repeater 103 in the transmission link may be connected to the transmission network 102 in a wired transmission way such as optical fiber and network cable, or in the wireless transmission modes such as Wi-Fi and Bluetooth. The repeater 103 may be connected with another repeater 103 by a wireless transmission channel of the 5G direct communication. The last repeater 103 in the transmission link may be connected to the terminal 104 by at least one of 5G direct communication, Wi-Fi and satellite flash wireless communication technologies.

In this embodiment, the same transmission resources may be multiplexed without co-frequency interference, and the utilization efficiency of the transmission resources may be effectively improved. Meanwhile, there is no need for scheduling permission, and the communication data may be transmitted between the repeaters without routing transmission, thus realizing low-delay communication and effectively improving the efficiency and effect of emergency communication.

In embodiments of the disclosure, the multiple repeaters 103 build the transmission link. The transmission link transmits the communication data sent by the terminal 104 based on the preset rule. FIG. 2 is a flow chart illustrating transmission based on a preset rule according to another embodiment of the disclosure.

As illustrated in FIG. 2, transmitting the communication data sent by the terminal based on the preset rule includes actions at blocks S201 to S203.

At block S201, multiple repeaters are sequentially numbered based on the transmission link, and the multiple repeaters are arranged based on a numeral order.

In embodiments of the disclosure, the multiple repeaters may be numbered sequentially. For example, according to an order of the repeaters in the transmission link, the repeaters are numbered sequentially as “repeater 1”, “repeater 2” and “repeater 3”, and so on, which is not limited herein.

In embodiments of the disclosure, the multiple repeaters are arranged in the numerical order. That is, in the case that there are the multiple repeaters 103 in the transmission link, the multiple repeaters 103 are arranged in the numerical order. Taking that there are three repeaters 103 as an example, the “repeater 1” is connected with the transmission network 102 and the “repeater 2”, and the “repeater 2” is connected with the “repeater 1” and the “repeater 3” to form a sequential order of the “repeater 1”, the “repeater 2” and the “repeater 3”.

According to embodiments of the disclosure, the multiple repeaters are sequentially numbered, and the multiple repeaters 103 are arranged based on the numerical order, such that the numbering configuration may be performed on the repeaters effectively, facilitating the regulation and management on the repeaters 103 are, and facilitating determining relevant information of the repeater in the transmission process of the communication data based on the numerical of the repeater 103 in the transmission process of the communication data.

At block S202, frequency domain resources for transmitting the communication data are divided into at least one set of transmission resources by taking a time domain resource granularity of transmission resources for the communication data as a scheduling unit.

The scheduling unit of the transmission resources needed to transmit the communication data in a time domain may be called the time domain resource granularity. The time domain resource granularity may be, such as, a subframe, a time slot, an orthogonal frequency division multiplexing (OFDM) symbol, and so on, which is not limited herein.

The frequency domain resources for transmitting the communication data may be, such as, resources corresponding to a dedicated frequency band with 5855 MHz-5925 MHz for coordinating an intelligent transportation system (ITS).

The frequency domain resources used in the transmission of the communication data are divided into at least one resource set, which may be called a set of transmission resources. The set of transmission resources may be specifically, such as, a transmission channel. That is, frequency bands are divided into at least one transmission channel, which is not limited therein.

In embodiments of the disclosure, the time domain resource granularity of the transmission resources for the communication data may be taken as the scheduling unit, and the transmission frequency domain resources may be divided into at least one set of transmission resources.

In some embodiments of the disclosure, dividing the frequency domain resources for transmitting the communication data into the at least one set of transmission resources may be dividing the frequency domain resources for transmitting the communication data into a first set of transmission resources and a second set of transmission resources.

Both the first set of transmission resources and the second set of transmission resources are some of the transmission frequency domain resources. It may be understood that the first set of transmission resources may be employed when the repeater returns the communication data, and the second set of transmission resources may be employed when the repeater forwards the communication data. Of course, the first set of transmission resources can also be the set of transmission resources used when the repeater forwards the communication data, and correspondingly, the second set of transmission resources is the set of transmission resources used when the repeater returns the communication data, which is not limited by the embodiment of the present disclosure.

In embodiments of the disclosure, the ITS dedicated frequency band with 5855 MHz-5925 MHz may be evenly divided into two resource sets, that is, the first set of transmission resources and the second set of transmission resources. Alternatively, the first set of transmission resources and the second set of transmission resources may be divided based on an actual transmission requirement, or the first set of transmission resources and the second set of transmission resources may be divided by any other possible division rule, which is not limited herein.

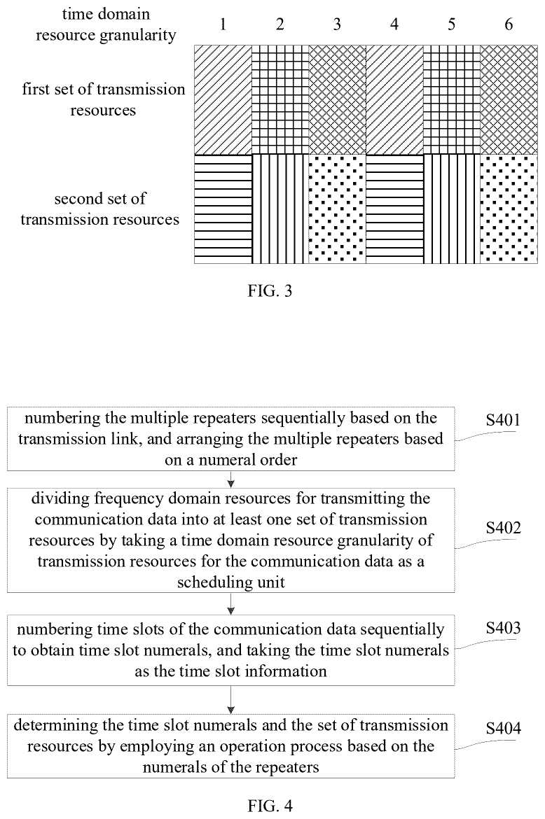

For example, as illustrated in FIG. 3, FIG. 3 is a schematic diagram illustrating allocating frequency domain resources for transmission according to another embodiment of the disclosure, in which the vertical direction represents the number of time domain resource granularities, and the horizontal direction represents the first set of transmission resources and the second set of transmission resources subjected to the dividing.

At block S203: time slot information and a set of transmission resources for transmitting the communication data are determined based on the numerals of the repeaters in combination with the preset rule.

The time slot information and the set of transmission resources are determined by an operation processing. The operation processing may be called the preset rule. Based on the number of devices that multiplex the same transmission resource in an interval and a numeral corresponding to a repeater that is transmitting the communication data currently, the time slot information and the set of transmission resources are determined based on a corresponding operation processing.

The number of devices that multiplex the same transmission resources in the interval is the number of repeaters between two adjacent repeaters that multiplex the same transmission resources. For example, in the case that the first repeater and the fourth repeater multiplex the same transmission resources and are separated by three repeaters, the number of devices that multiplex the same transmission resources is three.

It can be understood that certain transmission resources need to be employed when the repeater 103 transmits the communication data. The scheduling of the transmission resources is related to the efficiency and effect of emergency communication. Therefore, in embodiments of the disclosure, the transmission resources corresponding to the repeater 103 for currently transmitting the communication data are determined as soon as possible by employing the preset rule, thus improving the efficiency and effect of emergency communication.

In this embodiment, based on the transmission link, the multiple repeaters are sequentially numbered and arranged according to the numeral order, and the frequency domain resources for transmitting the communication data are divided into the at least one set of transmission resources by taking the time domain resource granularity of the transmission resources for the communication data as the scheduling unit, and then the time slot information and the set of transmission resources for transmitting the communication data are determined based on the numerals of the repeaters in combination with the preset rule. Since the preset rule is employed, the transmission resources corresponding to the repeater that currently transmits the communication data may be accurately determined, and the scheduling of the transmission resource may be effectively improved, thus improving the efficiency and effect of emergency communication.

FIG. 4 is a flow chart illustrating transmission based on a preset rule according to another embodiment of the disclosure.

As illustrated in FIG. 4, transmitting the communication data sent by the terminal based on the preset rule includes actions at blocks S401 to S404.

At block S401, the multiple repeaters are numbered sequentially based on the transmission link, and the multiple repeaters are arranged based on a numeral order.

At block S402, dividing frequency domain resources for transmitting the communication data into at least one set of transmission resources by taking a time domain resource granularity of transmission resources for the communication data as a scheduling unit.

Description of actions at block S401 to S404 may refer to the above embodiments, which is not elaborated herein.

At block S403, time slots of the communication data are numbered sequentially to obtain time slot numerals, and the time slot numerals are taken as the time slot information.

The time slot is a type of the time domain resource granularity corresponding to the transmission resources of the communication data. The transmission resources may be divided into multiple time slots, and the time slots divided may be numbered in order. For example, in the case that there are 10 time slots corresponding to the transmission resources, the transmission resources may be numbered as “time slot numeral 1”, “time slot numeral 2”, . . . , “time slot numeral 10” in order, and the time slot numerals corresponding to “time slot numeral 1-time slot numeral 10”.

In embodiments of the disclosure, the time slot corresponding to the time domain resource granularity may be numbered in advance to form the time slot numeral, and the time slot numeral may be dynamically changed based on an actual requirement. For example, a corresponding time slot numeral may be affected when the transmission resources are added or deleted, which is not limited herein.

The time slot numeral in embodiments of the disclosure may be calculated and determined based on the preset rule. A calculation process of the preset rule may be described in detail in the following embodiment.

At block S404, the time slot numerals and the set of transmission resources are determined by employing an operation process based on the numerals of the repeaters.

In some embodiments of the disclosure, determining the time slot numerals and the set of transmission resources by employing the operation process includes:

when the repeater receives the communication data:

$$mod ( Time resource\_number , N ) = mod ( SID , N ) ; \qquad ( 1 )$$

where, mod(x, y) represents a modulus function, which means a remainder obtained by x dividing y, Time resource_number represents the time slot information of the transmission resources, N represents a number of devices that multiplex the same transmission resources (N>2, and N is a positive integer) in an interval, and SID represents a numeral corresponding to a repeater to be configured to transmit the communication data.

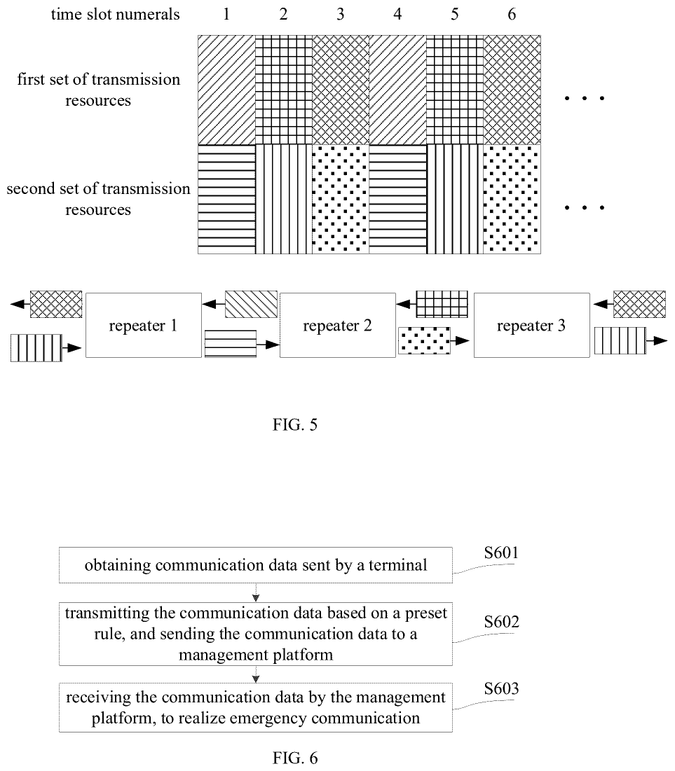

In embodiments of the disclosure, when the repeater 103 receives the communication data, the time slot information may be calculated by using the Formula (1). For example, as illustrated in FIG. 5, FIG. 5 is a schematic diagram illustrating allocating transmission resources according to another embodiment of the disclosure. In the transmission link, the number of devices that multiplex the same transmission resource in the interval is 3 (that is, N is 3), and the numerals are “repeater 1”, “repeater 2”, and “repeater 3” respectively. Meanwhile, the repeater is set to employ the second set of transmission resources when forwarding the communication data, and to employ the first set of transmission resources when returning the communication data. In the case that the repeater 2 (that is, SID is 2) forwards the communication data, a corresponding time slot numeral may be calculated as:

$$mod ( Time resource\_number , 3 ) = mod ( 2 , 3 ) .$$

After calculation, it is determined that corresponding time slot numerals employed when the repeater 2 receives and forwards the communication data may be a time slot numeral 2, a time slot numeral 5, a time slot numeral 8, a time slot numeral 11, . . . , a time slot numeral (2+3 m), etc., where mis a non-negative integer. Since there is determined the second set of transmission resources employed when the communication data is forwarded, corresponding transmission resources employed when the repeater 2 receiving and forwarding the communication data is a second set of transmission resources corresponding to the time slot numeral 2, or a second set of transmission resources corresponding to the time slot numeral 5.
when the repeater sends and forwards the communication data, the preset rule is

$$mod ( Time resource\_number , N ) = mod [ ( SID + N ) , N ] + 1. \qquad ( 2 )$$

In embodiments of the disclosure, when the repeater transmits and forwards the communication data, the time slot information may be calculated and determined by Formula (2). For example, as illustrated in FIG. 5, in the case that the repeater 2 (that is, SID is 2) forwards and sends the communication data, the corresponding time slot numeral may be calculated as:

$$mod ( Time resource\_number , 3 ) = mod [ ( 2 + 3 ) , 3 ] + 1.$$

After the calculation, it is determined that corresponding time slot numerals employed when the repeater 2 transmits and forwards communication data may be a time slot numeral 3, a time slot numeral 6, a time slot numeral 9, a time slot numeral 12, . . . , a time slot numeral (3+3 m), etc., where m is a non-negative integer. Since there is determined the second set of transmission resources employed when the communication data is forwarded, corresponding transmission resources employed when the repeater 2 sends and forwards the communication data is the second set of transmission resources corresponding to the time slot numeral 3, or the second set of transmission resources corresponding to the time slot numeral 6.

When the repeater sends and returns the communication data,
in the case that mod[(SID+N), N]−1=−1,

$$mod ( Time resource\_number , N ) = mod [ ( SID + N ) , N ] + N - 1 ; \qquad ( 3 )$$

in the case that mod[(SID+N), N]−1 #−1,

$$mod ( Time resource\_number , N ) = mod [ ( SID + N ) , N ] - 1 , \qquad ( 4 )$$

where, when SID is a multiple of N (SID is 1N, 2N, 3N and the like), mod[(SID+N), N]−1=−1; when SID is not a multiple of N (SID is not 1N, 2N, 3N and the like), mod[(SID+N), N]−1 #−1.

In other words, in the case that SID is a multiple of N, Formula (3) is employed for calculation when the repeater sends and returns the communication data. For example, as illustrated in FIG. 5, in the case that the repeater 3 (that is, SID is 3) sends and returns the communication data, the corresponding time slot numeral may be calculated as:

$$mod ( Time resource\_number , 3 ) = mod [ ( 3 + 3 ) , 3 ] + 3 - 1.$$

After the calculation, it is determined that corresponding time slot numerals employed when the repeater 3 sends and returns the communication data may be a time slot numeral 2, a time slot numeral 5, a time slot numeral 8, a time slot numeral 11, . . . , a time slot numeral (2+3 m), etc., where m is a non-negative integer. Since there is determined the first set of transmission resources employed when the communication data is returned, corresponding transmission resources employed when the repeater 3 sends and returns the communication data are the first set of transmission resources corresponding to the time slot numeral 2, or the first set of transmission resources corresponding to the first set of transmission resources corresponding to the time slot numeral 5.

Similarly, in the case that SID is not a multiple of N, Formula (4) is employed for calculation when the repeater sends and returns the communication data. For example, as illustrated in FIG. 5, in the case that the repeater 2 (that is, SID is 2) sends and returns the communication data, the corresponding time slot numeral may be calculated as:

$$mod ( Time resource\_number , 3 ) = mod [ ( 2 + 3 ) , 3 ] - 1.$$

After the calculation, it is determined that corresponding time slot numerals employed when the repeater 2 sends and returns the communication data may be time slot numeral 1, time slot numeral 4, time slot numeral 7, time slot numeral 10, . . . , time slot numeral (1+3 m), etc., where m is a non-negative integer. Since there is determined the first set of transmission resources employed when the communication data is returned, corresponding transmission resources employed when the repeater 2 sends and returns the communication data are the first set of transmission resources corresponding to the time slot numeral 1, or the first set of transmission resources corresponding to the first set of transmission resources corresponding to the time slot numeral 4.

In embodiments of the disclosure, the repeater may wait for N+1 time slots at most based on the preset rule, so that the repeater may transmit next communication data. In a sub-carrier space (SCS) with 30 KHz (including but not limited to 30 KHz), a maximum air interface delay is 0.5(N+1) ms, an overall delay is 0.5-0.5(N+1) ms, an average value is (N+2)/4 ms, and a maximum delay of 20 hops is 10(N+1) ms, which is calculated as 5(N+2) ms based on an average value.

Taking N as 3 as an example, in an SCS with 30 KHz, a maximum air interface delay is 2 ms, an overall delay is 0.5-2 ms, an average value is 1.25 ms, and an overall delay is 25 ms, which is obviously better than the international leading level of 50 ms, that is to say, the solution of embodiments of the disclosure has a lower transmission delay.

In the above embodiment, the preset rule is described in detail, such that the repeater 103 quickly determines the transmission resources during the transmission of the communication data. Meanwhile, resource configuration during the transmission of communication data is performed by taking the number of devices that multiplex the same transmission resources in the interval as a period, which may realize the multiplex of the transmission resources, improve the resource utilization efficiency, effectively avoid co-frequency interference, and effectively improve the efficiency and effect of mine emergency communication.

In some embodiments of the disclosure, in the case that, in the transmission link, the number of devices that multiplex the same transmission resources in the interval is greater than three, the time slot employed when the repeater transmits the communication data is in an idle state, and the number of time slots in the idle state is:

$$Sleep : Number\_slot = N - 3 ,$$

where, Sleep: Number_slot represents the time slot in the idle state employed when the repeater transmits the communication data.

It may be understood that, when the number (that is, N) of devices that multiplex the same transmission resources in the transmission link is greater than 3, for each repeater 103 in the corresponding transmission link, there may be N−3 time slots in the idle state. That is to say, when the number of devices that multiplex the same transmission resources in the transmission link in the interval is more than 3, there is no need for all repeaters in the transmission link to be in a transceiver working state. Therefore, there is no need to employ a repeater that supports a full duplex operation, thus effectively reducing a selection condition of the repeater and reducing the transmission power consumption.

In some embodiments of the disclosure, in the case that N=3, the utilization rate of the transmission resources is the highest. In the case that N=4, the repeater 103 is in the half-duplex state, and the utilization rate of the transmission resources is the highest. That is, in the case that N=3, there is no repeater 103 in the idle state in the transmission link, so the utilization rate of the transmission resources is the highest. In the case that N=4, the repeaters in the transmission link are in the half-duplex state, and each repeater is in the idle state for a quarter of the time. In the case that N>4, the repeaters in the transmission link are in the half-duplex state, but the time corresponding to the idle state of the repeater 103 increases, and the utilization rate of the transmission resources decreases.

For example, when the number of devices that multiplex the same transmission resources in the transmission link in the interval is 4, the number of idle time slots is 1, that is, each repeater is in the idle state for a quarter of the time, and there is no need for the repeater to be in the transceiver state all the time, thus effectively reducing the power consumption by 25%.

FIG. 6 is a flow chart illustrating a method for mining mobile emergency communication according to an embodiment of the disclosure;

As illustrated in FIG. 6, the method for mining mobile emergency communication includes blocks S601 to S603.

At block S601, communication data sent by a terminal is obtained.

In some embodiments, the communication data may be generated by the terminal 104 and sent to a repeater 103, and the repeater 103 receives and obtains the communication data sent by the terminal 104.

In some embodiments, a management platform 101 may also send an obtaining instruction of the communication data to obtain the communication data generated by the terminal 104.

Of course, the communication data sent by the terminal 104 may also be obtained by any other possible implementation, which is not limited herein.

At block S602, the communication data is transmitted based on a preset rule, and the communication data is sent to a management platform.

In embodiments of the disclosure, the repeater may determine the transmission resources for transmitting the communication data based on the preset rule, such that the transmission resources are employed to transmit the communication data.

In some embodiments of the disclosure, transmitting the communication data based on the preset rule may be: sequentially numbering multiple repeaters based on a transmission link, arranging the multiple repeaters based on a numeral order, dividing frequency domain resources for transmitting the communication data into at least one set of transmission resources by taking a time domain resource granularity of the transmission resources for the communication data as a scheduling unit, and determining time slot information and a set of transmission resources for transmitting the communication data in combination with the preset rule based on the numerals of the repeaters, thus accurately determining the transmission resources corresponding to the repeater for transmitting the communication data, effectively improving the efficiency of the scheduling of the transmission resources, and further improving the efficiency and effect of emergency communication.

In embodiments of the disclosure, the multiple repeaters may multiplex the same transmission resources, and the multiple repeaters are numbered in order, such that the transmission resources employed by the repeaters may be managed more conveniently.

At block S603, the communication data by the management platform is received, to realize emergency communication.

In embodiments of the disclosure, the management platform 101 receives the communication data and analyzes the communication data, thus realizing emergency communication.

In this embodiment, the communication data sent by the terminal is obtained, the communication data is transmitted based on the preset rule, the communication data is sent to the management platform, the management platform receives the communication data, to realize emergency communication. The communication data transmitted by the repeaters is scheduled based on the preset rule, the same transmission resources may be multiplexed without co-frequency interference, which effectively improves the utilization efficiency of the transmission resources. Meanwhile, there is no need for scheduling permission, and the communication data may be transmitted between repeaters without routing transmission, thus realizing a low-delay communication and effectively improving the efficiency and effect of emergency communication.

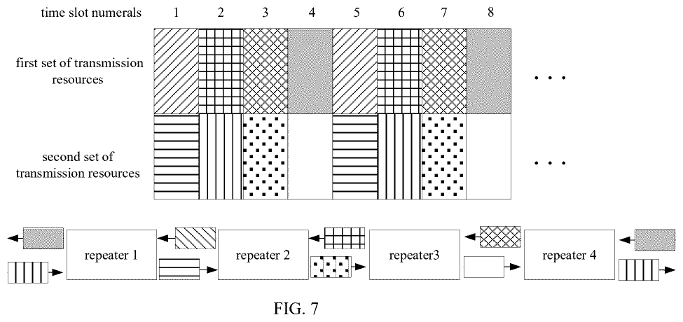

FIG. 7 is a schematic diagram illustrating transmission of communication data according to another embodiment of the disclosure. As illustrated in FIG. 7, the numerals of devices that multiplex the same transmission resources in the interval are 4. Exemplary description is made below to time slot information corresponding to a time slot numeral 1 to a time slot numeral 4.

Transmission resources for receiving the communication data by a repeater 1 are a second set of transmission resources and a set of first transmission resources in the time slot numeral 1, and transmission resources for transmitting the communication data are a first set of transmission resources in the time slot numeral 4 and a second set of transmission resources in the time slot numeral 2 (the repeater is in an idle state in the time slot numeral 3);

Transmission resources for receiving the communication data by a repeater 2 are the second set of transmission resources and a first set of transmission resources in the time slot numeral 2, and transmission resources for transmitting the communication data are the first set of transmission resources in the time slot numeral 1 and a second set of transmission resources in the time slot numeral 3 (the repeater is in the idle state in the time slot numeral 4);

Transmission resources for receiving the communication data by a repeater 3 are the second set of transmission resources and the first set of transmission resources in the time slot numeral 3, and the transmission resources for transmitting the communication data are the first set of transmission resources in the time slot numeral 2 and a second set of transmission resources in the time slot numeral 4 (the repeater is in the idle state in the time slot numeral 1);

Transmission resources for receiving the communication data by a repeater 4 are the second set of transmission resources and the first set of transmission resources in the time slot numeral 4, and transmission resources for transmitting the communication data are the first set of transmission resources in the time slot numeral 3 and the second set of transmission resources in the time slot numeral 1 (the repeater is in the idle state in the time slot numeral 2).

It may be understood that, the transmission rule of the time slot numeral 1-time slot numeral 4 are repeated in the time slot numeral 5-time slot numeral 8, and the same is repeated in the time slot numeral 9-time slot numeral 12 and the like, which is not limited.

It can be known in FIG. 7 that the multiple repeaters transmit the communication data based on the preset rule, which effectively avoids co-frequency interference. Meanwhile, each repeater has idle time, effectively reducing power consumption.

It should be noted that, in the description of the disclosure, the terms “first” and “second” are only for description purpose, and cannot be understood as indicating or implying relative importance. In addition, in the description of the disclosure, the term “multiple” means two or more, such as two and three, unless specified otherwise.

Any procedure or method described in a flow chart or described herein in other ways may be understood to include one or more modules, segments or portions of codes of executable instructions for achieving specific logical functions or steps in the procedure, and the scope of a preferred embodiment of the disclosure includes other implementations. The order of execution is different from that which is depicted or discussed, including executing functions in a substantially simultaneous manner or in an opposite order according to the related functions, which should be understood by those skilled in the art which embodiments of the disclosure belong to.

It should be understood that each part of the disclosure may be realized by the hardware, software, firmware or their combination. In the above embodiments, multiple steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or some of the steps in the above embodiment method may be achieved by commanding the related hardware with a program. The program may be stored in a computer readable storage medium, and the program includes one or a combination of the steps in the method embodiments when is operated.

In addition, each function unit of each embodiment of the disclosure may be integrated in a processing module, or these units may be separate physical existence, or two or more units are integrated in a processing module. The integrated module may be realized in a form of hardware or in a form of software function modules. When the integrated module is realized in the form of software function module and is sold or used as a standalone product, the integrated module may be stored in a computer readable storage medium.

The storage medium mentioned above may be a read-only memory, a magnetic disk or CD, etc.

In the description of the disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the disclosure. The appearances of the phrases in various places throughout this specification are not necessarily referring to the same embodiment or example of the disclosure. Furthermore, the particular features, structures, materials, or characteristics may be combined in any suitable manner in one or more embodiments or examples.

Although embodiments of the disclosure have been illustrated and described above, it may be understood that the above embodiments are exemplary and should not be construed as limiting the disclosure. The skilled in the art may make changes, modifications, substitutions and variations to the above embodiments within the scope of the disclosure.

1. A system for mining mobile emergency communication, comprising:
a management platform, a transmission network, a repeater and a terminal, wherein
the terminal is configured to collect and generate communication data, and to send the communication data to the repeater;
the repeater is connected with the transmission network and/or connected with another repeater in a wireless way for building a transmission link, the transmission link transmitting the communication data sent by the terminal based on a preset rule;
the management platform is configured to monitor and schedule the transmission link, and to schedule the communication data; and
the transmission network is configured to connect the repeater and the management platform, and to transmit the communication data and link regulation and control data.

2. The system of claim 1, wherein there are a plurality of repeaters, and the transmission link transmits the communication data sent by the terminal based on the preset rule, comprising:
numbering the plurality of repeaters sequentially based on the transmission link, and arranging the plurality of repeaters based on a numeral order;
dividing frequency domain resources for transmitting the communication data into at least one set of transmission resources by taking a time domain resource granularity of transmission resources for the communication data as a scheduling unit; and
determining time slot information and a set of transmission resources for transmitting the communication data based on the numerals of the repeaters in combination with the preset rule.

3. The system of claim 2, wherein dividing the frequency domain resources for transmitting the communication data into the at least one set of transmission resources comprises:
dividing the frequency domain resources for transmitting the communication data into a first set of transmission resources and a second set of transmission resources, wherein the first set of transmission resources is a set of transmission resources employed when the repeater returns the communication data, and the second set of transmission resources is a set of transmission resources employed when the repeater forwards the communication data.

4. The system of claim 2, wherein determining the time slot information and the set of transmission resources for transmitting the communication data based on the numerals of the repeaters in combination with the preset rule comprises:
numbering time slots of the communication data sequentially to obtain time slot numerals, and taking the time slot numerals as the time slot information; and
determining the time slot numerals and the set of transmission resources by employing an operation process based on the numerals of the repeaters.

5. The system of claim 4, wherein determining the time slot numerals and the set of transmission resources by employing the operation process is based on at least one of:
mod(Time resource_number,N)=mod(SID,N) in the case that the repeater receives the communication data;
where, mod(x, y) represents a modulus function, which means a remainder obtained by x dividing y, Time resource_number represents the time slot information of the transmission resources, N represents a number of devices that multiplex the same transmission resources (N>2, and N is a positive integer) in an interval, and SID represents a numeral corresponding to a repeater to be configured to transmit the communication data;
mod(Time resource_number,N)=mod[(SID+N),N]+1 in the case that the repeater sends and forwards the communication data, or
mod(Time resource_number, N)=mod[(SID+N), N]+N−1 in the case that the repeater sends and returns the communication data, and mod[(SID+N), N]−1=−1; or mod (Time resource_number, N)=mod[(SID+N), N]−1 in the case that the repeater sends and returns the communication data, and
mod[(SID+N),N]−1≠−1.

6. The system of claim 1, wherein the repeater is connected to the transmission network in a wired or wireless way and is connected to another repeater in a wireless transmission way of 5th generation mobile communication technology (5G) direct communication, to form the transmission link.

7. The system of claim 5, wherein, in the transmission link, the number of devices that multiplex the same transmission resources in the interval is greater than three, and a time slot employed when the repeater transmits the communication data is in an idle state, and the number of time slots in the idle state is:
$$Sleep : Number\_slot = N - 3 ,$$
where, Sleep: Number_slot represents the number of time slots in the idle state when the repeater transmits the communication data.

8. The system of claim 1, wherein the repeater employs an intelligent transport system (ITS) dedicated frequency band with 5855 MHz-5925 MHz.

9. A method for mining mobile emergency communication, performed by a system for mining mobile emergency communication, comprising:
obtaining communication data sent by a terminal;
transmitting the communication data based on a preset rule, and sending the communication data to a management platform; and
receiving the communication data by the management platform, and performing emergency communication based on the communication data.

10. The method of claim 9, wherein transmitting the communication data based on the preset rule comprises:
numbering a plurality of repeaters sequentially based on a transmission link, and arranging the plurality of repeaters sequentially based numerals;
dividing frequency domain resources transmitted by the communication data into at least one transmission resource set by taking a time domain resource granularity of transmission resources of the communication data as a scheduling unit; and
determining time slot information and a transmission resource set for transmitting the communication data based on the numerals of the repeaters in combination with the preset rule.

11. The method of claim 10, wherein dividing the frequency domain resources for transmitting the communication data into the at least one set of transmission resources comprises:
dividing the frequency domain resources for transmitting the communication data into a first set of transmission resources and a second set of transmission resources, wherein the first set of transmission resources is a set of transmission resources employed when the repeater returns the communication data, and the second set of transmission resources is a set of transmission resources employed when the repeater forwards the communication data.

12. The method of claim 10, wherein determining the time slot information and the set of transmission resources for transmitting the communication data based on the numerals of the repeaters in combination with the preset rule comprises:
numbering time slots of the communication data sequentially to obtain time slot numerals, and taking the time slot numerals as the time slot information; and
determining the time slot numerals and the set of transmission resources by employing an operation process based on the numerals of the repeaters.

13. The method of claim 12, wherein determining the time slot numerals and the set of transmission resources by employing the operation process is based on at least one of:
mod(Time resource_number, N)=mod(SID, N) in the case that the repeater receives the communication data;
where, mod(x, y) represents a modulus function, which means a remainder obtained by x dividing y, Time resource_number represents the time slot information of the transmission resources, N represents a number of devices that multiplex the same transmission resources (N>2, and N is a positive integer) in an interval, and SID represents a numeral corresponding to a repeater to be configured to transmit the communication data;
mod(Time resource_number,N)=mod[(SID+N),N]+1 in the case that the repeater sends and forwards the communication data; or
mod (Time resource_number, N)=mod[(SID+N), N]+N−1 in the case that the repeater sends and returns the communication data, and mod[(SID+N),N]−1=−1; or
mod (Time resource_number, N)=mod[(SID+N), N]−1 in the case that the repeater sends and returns the communication data, and mod[(SID+N), N]−1≠−1.

14. The method of claim 9, wherein the repeater is connected to the transmission network in a wired or wireless way and is connected to another repeater in a wireless transmission way of 5th generation mobile communication technology (5G) direct communication, to form the transmission link.

15. The method of claim 13, wherein, in the transmission link, the number of devices that multiplex the same transmission resources in the interval is greater than three, and a time slot employed when the repeater transmits the communication data is in an idle state, and the number of time slots in the idle state is:
$$Sleep : Number\_slot = N - 3 ,$$
where, Sleep: Number_slot represents the number of time slots in the idle state when the repeater transmits the communication data.

16. The method of claim 9, wherein the repeater employs an intelligent transport system (ITS) dedicated frequency band with 5855 MHz-5925 MHz.

17. A non-transitory computer-readable storage medium having a computer program stored thereon, when executed by a processor, cause the following operations to be implemented:
obtaining communication data sent by a terminal;
transmitting the communication data based on a preset rule, and sending the communication data to a management platform; and
receiving the communication data by the management platform, and performing emergency communication based on the communication data.

18. The non-transitory computer-readable storage medium of claim 17, wherein the processor is configured to:
number a plurality of repeaters sequentially based on a transmission link, and arrange the plurality of repeaters sequentially based numerals;
divide frequency domain resources transmitted by the communication data into at least one transmission resource set by taking a time domain resource granularity of transmission resources of the communication data as a scheduling unit; and
determine time slot information and a transmission resource set for transmitting the communication data based on the numerals of the repeaters in combination with the preset rule.

19. The non-transitory computer-readable storage medium of claim 18, wherein the processor is configured to:
divide the frequency domain resources for transmitting the communication data into a first set of transmission resources and a second set of transmission resources, wherein the first set of transmission resources is a set of transmission resources employed when the repeater returns the communication data, and the second set of transmission resources is a set of transmission resources employed when the repeater forwards the communication data.

20. The non-transitory computer-readable storage medium of claim 18, wherein the processor is configured to:
number time slots of the communication data sequentially to obtain time slot numerals, and take the time slot numerals as the time slot information; and
determine the time slot numerals and the set of transmission resources by employing an operation process based on the numerals of the repeaters.
